(19) United States
(12) Patent Application Publication
(10) Pub. No.: US 2019/0000123 A1
(43) Pub. Date: Jan. 3, 2019

(54) ENHANCED SALT COMPOSITIONS AND METHODS OF PREPARATION THEREOF

(71) Applicant: DOUXMATOK LTD., Tel-Aviv (IL)

(72) Inventors: Avraham BANIEL, Jerusalem (IL); Michael ZVIELY, Haifa (IL); Ronit ROMM, Jerusalam (IL); Sivan NAHUM, Safed (IL)

(21) Appl. No.: 15/576,681

(22) PCT Filed: May 26, 2016
(86) PCT No.: PCT/IB2016/000818

§ 371 Date: Nov. 22, 2017

Related U.S. Application Data
(60) Provisional application No. 62/167,162, filed on May 27, 2015.

(51) Int. Cl. A23L 27/40; A23L 27/00

(52) U.S. Cl. CPC A23L 27/40; A23V 2002/00; A23L 27/88

(57) ABSTRACT

Provided herein are compositions with enhanced saltiness or reduced sodium content per weight when compared to the salt component thereof, and methods for the preparation thereof.

### BACKGROUND OF THE DISCLOSURE

The present disclosure relates to enhanced salt compositions. More particularly, the present disclosure relates to enhanced salt compositions having enhanced saltiness and/or reduced sodium content as compared to that of the salt component thereof, and to methods for the preparation thereof.

Sodium chloride (NaCl) salt is commonly used to season, flavor, or preserve food. Excess sodium intake can pose several health problems. In such cases, a method to increase the saltiness of a salt or to reduce the amount of a salt while achieving equivalent saltiness is desired. The present disclosure provides for the manipulation of the relationship between saltiness and salt amount or sodium content so that a desired saltiness may correlate with lower salt amount or lower sodium values while retaining a similar sensory profile to the salt. This effect is achieved through the presentation of the salt in the form of a composition belonging to a class of compositions described below. The perception of saltiness of a salt is retained while reducing the sodium value thereof by virtue of it being provided in a composition as described herein.

### SUMMARY OF THE DISCLOSURE

In one aspect, the present disclosure provides a method of producing an enhanced salt composition, comprising mixing a salt with an enhancer compound to produce an enhanced salt composition; wherein the enhanced salt composition has enhanced saltiness compared to a control composition; and wherein the control composition consists of the same contents by identity and quantity as the enhanced salt composition but without the enhancer compound. In some embodiments, the method further comprises dissolving the salt and the enhancer compound to produce an enhanced salt composition solution. In some embodiments, the method further comprises adjusting a pH level of the enhanced salt composition solution. In some embodiments, the method further comprises drying the enhanced salt composition. In some embodiments, the method further comprises sonicating the enhanced salt composition. In some embodiments, the method further comprises homogenizing the enhanced salt composition. In some embodiments, the method further comprises passing the enhanced salt composition through a sieve. In some embodiments of the method, the salt comprises sodium chloride. In some embodiments of the method, the enhancer compound is selected from the group consisting of an amino acid, peptide, protein, metal oxide, chitosan, chitin, and any combination thereof. In some embodiments of the method, the amino acid is selected from the group consisting of alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, selenocysteine, pyrrolysine, and any combination thereof. In some embodiments of the method, the amino acid is glycine. In some embodiments of the method, the amino acid is glycine and the salt comprises sodium chloride. In some embodiments of the method, the peptide is selected from the group consisting of a dipeptide, tripeptide, tetrapeptide, pentapeptide, and any combination thereof. In some embodiments of the method, the enhancer compound is a metal oxide. In some embodiments of the method, the enhancer compound is silicon dioxide. In some embodiments of the method, the enhancer compound is a metal oxide and the salt comprises sodium chloride. In some embodiments of the method, the enhancer compound is silicon dioxide and the salt comprises sodium chloride. In some embodiments of the method, the enhancer compound is a combination of two or more enhancer compounds. In some embodiments of the method, the enhanced salt composition comprises up to about 10% enhancer compound weight/weight relative to salt. In some embodiments of the method, the enhanced salt composition comprises about 0.1-10% enhancer compound weight/weight relative to salt. In some embodiments of the method, the enhanced salt composition comprises up to about 5% enhancer compound weight/weight relative to salt. In some embodiments of the method, the enhanced salt composition comprises about 0.1-5% enhancer compound weight/weight relative to salt. In some embodiments of the method, the saltiness is enhanced by at least 10, 20, 30, 40, or 50%.

In another aspect, the present disclosure provides an enhanced salt composition comprising a salt and an enhancer compound; wherein the enhanced salt composition has up to about 10% enhancer compound weight/weight relative to salt; wherein the enhanced salt composition has enhanced saltiness compared to a control composition; and wherein the control composition consists of the same contents by identity and quantity as the enhanced salt composition but without the enhancer compound. In some embodiments, the enhanced salt composition comprises about 0.1-10% enhancer compound weight/weight relative to salt. In some embodiments, the enhanced salt composition comprises up to about 5% enhancer compound weight/weight relative to salt. In some embodiments, the enhanced salt composition comprises about 0.1-5% enhancer compound weight/weight relative to salt. In some embodiments of the enhanced salt composition, the salt comprises sodium chloride. In some embodiments of the enhanced salt composition, the enhancer compound is selected from the group consisting of an amino acid, peptide, protein, metal oxide, chitosan, chitin, and any combination thereof. In some embodiments of the enhanced salt composition, the amino acid is selected from the group consisting of alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, selenocysteine, pyrrolysine, and any combination thereof In some embodiments of the enhanced salt composition, the amino acid is glycine. In some embodiments of the enhanced salt composition, the amino acid is glycine and the salt comprises sodium chloride. In some embodiments of the enhanced salt composition, the peptide is selected from the group consisting of a dipeptide, tripeptide, tetrapeptide, pentapeptide, and any combination thereof. In some embodiments of the enhanced salt composition, the enhancer compound is a metal oxide. In some embodiments of the enhanced salt composition, the enhancer compound is silicon dioxide. In some embodiments of the enhanced salt composition, the enhancer compound is a metal oxide and the salt comprises sodium chloride. In some embodiments of the enhanced salt composition, the enhancer compound is silicon dioxide and the salt comprises sodium chloride. In some embodiments of the enhanced salt composition, the enhancer compound is a combination of two or more enhancer compounds. In some embodiments of the enhanced salt composition, the enhanced salt composition is a solid. In some embodiments of the enhanced salt composition, the enhanced salt composition is a liquid. In some embodiments of the enhanced salt composition, the saltiness is enhanced by at least 10, 20, 30, 40, or 50%. In some embodiments of the enhanced salt composition, the composition consists essentially of a salt and an enhancer compound. In some embodiments of the enhanced salt composition, the composition consists of a salt and an enhancer compound.

In yet another aspect, the present disclosure provides a composition comprising a food or consumable product comprising an enhanced salt composition disclosed herein. In some embodiments of the composition, the food or consumable product is selected from the group consisting of baked goods, condiments (e.g., ketchup, sweet relish), sauces (e.g., fish sauce, soy sauce, spaghetti sauce, tomato sauce, teriyaki sauce, oyster sauce, hot sauce, steak sauce, barbeque sauce, Worcestershire sauce), dressings, meat (e.g., pork, beef, lamb, goat, poultry, chicken, turkey, fish, seafood, shellfish, crab, lobster, clam, oyster, shrimp), processed meats (e.g., sausage, salami, deli meat, lunch meat, cured meat, smoked meat, dried meat, canned meat, ground meat, bacon, ham, roast beef, corned beef, head cheese, charcuterie, pate, terrine, galantine, ballotine), hamburger, egg, vegetables (e.g., fresh vegetables, cooked vegetables, canned vegetables, frozen vegetables, fermented vegetables, pickled vegetables, pickles), cereal, pies, quiche, pasta, meat substitute, tofu, peanuts, nuts, seeds, snacks (e.g., pretzels, crackers, chips, French fries), cheese, spices, soup (e.g., canned soup, instant soup), dairy products, and any combination thereof.

In still another aspect, the present disclosure provides a method to make a food or consumable product comprising substituting at least a portion of a salt ingredient with an enhanced salt composition disclosed herein.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

The novel features of the disclosure are set forth with particularity in the appended claims. A better understanding of the features and advantages of the present disclosure will be obtained by reference to the following detailed description that sets forth illustrative embodiments, in which the principles of the disclosure are utilized.

### DETAILED DESCRIPTION OF THE DISCLOSURE

### Introduction

The present disclosure relates to salt compositions that can be used alone or added to or further processed into a consumable product. The enhanced salt compositions herein comprise a salt and an enhancer compound. The enhanced salt compositions herein may be saltier in taste than a similar control composition (e.g., a composition comprising the same contents by identity and quantity as the salt but without the enhancer compound).

### Definitions

As used herein, the term “salt” refers to a consumable salt, which produces a salty taste when consumed alone. A salt may be a naturally occurring salt; for example, it may be an isolated, purified salt. Non-limiting examples of a salt include sodium chloride, potassium chloride, ammonium chloride, sodium salt, potassium salt, ammonium salt, chloride salt, sodium alginate, sodium ascorbate, sodium bicarbonate (baking soda), sodium benzoate, sodium caseinate, sodium citrate, sodium hydroxide, sodium saccharin, sodium stearoyl lactylate, sodium sulfite, disodium phosphate, monosodium glutamate (MSG), trisodium phosphate, disodium guanylate, disodium inosinate, disodium ribonucleotides, table salt, common salt, sea salt, iodized salt, Kosher salt, rock salt, flavored salt, seasoned salt, finishing salt, and smoked salt. A salt may be a combination of two or more distinct salts. A salt may be fish sauce, soy sauce, or an herb (e.g., saltbush, Atriplex).

As used herein, the term “enhancer compound” refers to a food-grade compound, which may associate with a salt. An enhancer compound may associate with a salt by forming electrostatic interactions, hydrogen bonds, ionic interactions, coordinative interactions, non-covalent interactions, van der Waals interactions, or any combination thereof with the salt. The enhancer compound may associate with the salt to provide characteristics different than a control composition, for instance enhanced saltiness. An enhancer compound may be tasteless, flavorless, or odorless. An enhancer compound optionally meets test requirements as described in the Food Chemicals Codex (FCC), the European Directive, or Japan's Specifications and Standards for Food Additives. An enhancer compound can be purified or isolated. An enhancer compound may be a combination of two or more distinct enhancer compounds. In some cases, an enhancer compound may be a combination of 2, 3, 4, 5, 6, 7, 8, 9, 10, or more distinct enhancer compounds. In some cases, the saltiness of an enhanced salt composition can have a ratio of enhancer compound to salt that provides a maximum saltiness. In some cases, increasing the amount of enhancer compound relative to salt beyond the maximum point can decrease the saltiness of the composition. In some cases, when the amount of enhancer compound is less than the maximum point, the composition does not fully benefit from the saltiness enhancement effect of the enhancer compound. Non-limiting examples of an enhancer compound include an amino acid, peptide, protein, metal oxide (e.g., titanium dioxide, silicon dioxide (e.g., silica), zinc oxide, aluminum oxide), chitosan, chitin, and any combination thereof.

Non-limiting examples of an amino acid include alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, selenocysteine, and pyrrolysine. In some cases, an amino acid is a proteinogenic, natural, standard, non-standard, non-canonical, essential, non-essential, or non-natural amino acid. In some cases, an amino acid is an alpha (α) amino acid, beta (β) amino acid, gamma (γ) amino acid, or delta (δ) amino acid. In some cases, an amino acid has a positively charged side chain, a negatively charged side chain, a polar uncharged side chain, a non-polar side chain, a hydrophobic side chain, a hydrophilic side chain, an aliphatic side chain, an aromatic side chain, a cyclic side chain, an acyclic side chain, a basic side chain, or an acidic side chain. In some cases, an amino acid is an L-stereoisomer or L-amino acid. In some cases, an amino acid is a D-stereoisomer or D-amino acid. In some cases, an amino acid is neutral in charge. In some cases, an amino acid is in an anionic, cationic, zwitterion, or salt form (e.g., sodium glutamate form of glutamic acid). In some cases, an amino acid is derivatized. In some cases, an amino acid has an N-lactoyl-X structure, where X represents an amino acid residue. In some cases, an amino acid with an N-lactoyl-X structure is selected from the group consisting of N—(S)-Lactoyl-Glu, N—(S)-Lactoyl-Ala, N—(S)-Lactoyl-Leu, N—(S)-Lactoyl-Tyr, N—(S)-Lactoyl-Met, and any combination thereof.

A peptide may include two or more amino acids. In some cases, a peptide may include about 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, or 100 amino acids. In some cases, a peptide may include at least 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, or 100 amino acids. In some cases, a peptide may include up to 2, 3, 4, 5, 6, 7, 8, 9, 10, 11, 12, 13, 14, 15, 16, 17, 18, 19, 20, 21, 22, 23, 24, 25, 30, 35, 40, 45, 50, 55, 60, 65, 70, 75, 80, 85, 90, 95, or 100 amino acids. In some cases, a peptide may include from 2-100, 2-50, 2-20, 2-10, 2-9, 2-8, 2-7, 2-6, 2-5, 2-4, 2-3, 3-100, 3-50, 3-20, 3-10, 3-9, 3-8, 3-7, 3-6, 3-5, 3-4, 4-100, 4-50, 4-20, 4-10, 4-9, 4-8, 4-7, 4-6, 4-5, 5-100, 5-50, 5-20, 5-10, 5-9, 5-8, 5-7, 5-6, 6-100, 6-50, 6-20, 6-10, 6-9, 6-8, or 6-7 amino acids. In some cases, a peptide may be a dipeptide, tripeptide, tetrapeptide, or pentapeptide. In some cases, a peptide (e.g., tripeptide) contains a hydrophobic amino acid residue (e.g., alanine (Ala), methionine (Met), valine (Val), leucine (Leu), proline (Pro), phenylalanine (Phe), tyrosine (Tyr), isoleucine (Ile), or tryptophan (Trp)) and at least one acidic amino acid residue (e.g., glutamic acid (Glu) or aspartic acid (Asp)). In some cases, a peptide (e.g., tripeptide) contains two acidic amino acid residues. In some cases, a tripeptide is selected from the group consisting of Glu-Glu-Leu, Glu(Glu-Leu) or γGlu-Glu-Leu, Leu-Glu-Glu, Glu-Asp-Phe, Glu-Glu-Ile, Asp-Glu-Leu, Glu-Leu-Glu, Glu-Asp-Ile, Asp-Glu-Ile, Glu-Glu-Val, Lys-Asp-Ile, Asp-Ile-Gly, and any combination thereof.

As used herein, the term “control composition” refers to a composition, to which an enhanced salt composition is compared. In some cases, a control composition comprises the salt but not the enhancer compound of the enhanced salt composition to which it is compared. In some cases, a salt in a control composition is in free, unassociated form. The control composition may comprise the same contents by identity and quantity as the salt of an enhanced salt composition. The control composition may consist of the same contents by identity and quantity as the salt of an enhanced salt composition. The control composition may consist of the same contents by identity and quantity as the enhanced salt composition but without the enhancer compound.

As used herein, the term “enhanced saltiness” or “higher perceived saltiness” refers to a stronger or greater sense of saltiness to a human. Enhanced salt compositions with enhanced saltiness taste saltier than the control composition to which they are compared. A smaller amount (by weight or by volume) of an enhanced salt composition with enhanced saltiness may produce the same sense of saltiness as a larger amount (by weight or by volume) of a control composition that lacks enhanced saltiness. An enhanced salt composition with enhanced saltiness may produce a higher perceived saltiness and have a lower sodium content than a control composition with a comparable amount (by weight) of the salt in free, unassociated form. For example, 1.0 grams of an enhanced salt composition comprising about 0.01 grams of an enhancer compound and about 0.99 grams of a salt may produce a higher perceived saltiness than a control composition that comprises about 0.99 grams of the salt and does not comprise the enhancer compound.

As used herein, the term “consumable product” refers to a product, which may be consumed (e.g., by eating, chewing, tasting, drinking, or swallowing). Consumable products may include food products as non-limiting examples. Food products include, but are not limited to, soup (e.g., canned soup, instant soup), whipped cream, baked goods, condiments (e.g., ketchup, sweet relish), sauces (e.g., fish sauce, soy sauce, spaghetti sauce, tomato sauce, teriyaki sauce, oyster sauce, hot sauce, steak sauce, barbeque sauce, Worcestershire sauce), dairy products, dressings, meat (e.g., pork, beef, lamb, goat, poultry, chicken, turkey, fish, seafood, shellfish, crab, lobster, clam, oyster, shrimp), processed meats (e.g., sausage, salami, deli meat, lunch meat, cured meat, smoked meat, dried meat, canned meat, ground meat, bacon, ham, roast beef, corned beef, head cheese, charcuterie, pate, terrine, galantine, ballotine), hamburger, egg, vegetables (e.g., fresh vegetables, cooked vegetables, canned vegetables, frozen vegetables, fermented vegetables, pickled vegetables, pickles), cereal, pies, quiche, pasta, meat substitute, tofu, peanuts, nuts, seeds, snacks (e.g., pretzels, crackers, chips, French fries), spices, and cheese. In some cases, a food product is frozen, freeze-dried, canned, preserved, cured, dried, smoked, baked, fermented, pickled, jellied, treated with lye, or fried.

As used herein, the term “solvent” refers to a liquid, which may be mixed with or used to dissolve an enhanced salt composition or one or more components of an enhanced salt composition such as a salt or enhancer compound. Non-limiting examples of a solvent include water, ethanol, and isopropanol. The solvent can be potable. Non-limiting examples of water include purified water, distilled water, double distilled water, deionized water, distilled deionized water, drinking water, well water, tap water, spring water, bottled water, carbonated water, mineral water, flavored water, or any combination thereof. A solvent may be a combination of two or more distinct solvents.

An enhancer compound can comprise silica or silicon dioxide (SiO₂). In some embodiments, an enhancer compound is silica or silicon dioxide (SiO₂). Examples of silica contemplated herein include, but are not limited to, colloidal silica; silica particles (e.g., particles comprising silica); precipitated silica; porous silica; colloidal silica; dispersed silica; silica gel; silica sol; porous, precipitated silica; silica gel; amorphous silica; and precipitated, amorphous silica. Examples of silica enhancer compounds contemplated herein include, but are not limited to, Perkasil® (W. R. Grace & Co), Perkasil® SM 660 (W. R. Grace & Co), Syloid® (W. R. Grace & Co), Daraclar® (W. R. Grace & Co), Trisyl® (W. R. Grace & Co), Sylox® (W. R. Grace & Co), Silica gel® (W. R. Grace & Co), Tixosil® (Solvay), Tixosil® 38AB (Solvay), and Zeofree® (HUBER). In some cases, an enhancer compound comprising silicon dioxide has a SiO₂ (dry basis) content of about or at least about 98% or 99%. In some cases, an enhancer compound comprising silicon dioxide is synthetically produced, free flowing, amorphous, solid, white, spray dried, or a powder.

In some cases, an enhancer compound can have an average particle size of up to 1, 2, 3, 4, 5, 7, 8, 9, 10, 11, 12, 13, 14, 15, 20, 25, 30, 35, 40, 45, 50, 55, 60, 65, 70, 75, 80, 85, 90, 95, or 100 microns. In some cases, an enhancer compound can have an average particle size of about or at least 1, 2, 3, 4, 5, 7, 8, 9, 10, 11, 12, 13, 14, 15, 20, 25, 30, 35, 40, 45, 50, 55, 60, 65, 70, 75, 80, 85, 90, 95, or 100 microns. In some embodiments, an enhancer compound has an average particle size between 1 and 100, 5 and 100, 1 and 80, 10 and 80, 1 and 50, 10 and 50, 1 and 30, 1 and 10, 3.5 and 65, or 10 and 30 microns. In some cases, an average particle size is determined by Malvern Mastersizer, Malvern Mastersizer 2000, laser diffraction, or laser CILAS. In some cases, an enhancer compound has an average particle size of about 3, 7, 9, 10, or 19 microns determined by Malvern Mastersizer; an average particle size of about 10, 10.1, or 19.0 microns determined by Malvern Mastersizer 2000; an average particle size of about 12-25 microns determined by laser diffraction; or an average particle size of about 13, 14, 15, or 17 microns determined by laser CILAS. In some cases, an enhancer compound has a wet screen residue of less than about 0.01% for greater than 25 microns, up to about 0.2% for greater than 150 microns, or less than 0.1% or 0.2% for greater than 40 microns (Mocker).

An enhancer compound may have a high specific surface area. In some cases, an enhancer compound may have a specific surface area of about or at least 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 900, 950, or 1000 m²/g. In some cases, an enhancer compound may have a specific surface area of up to 20, 30, 40, 50, 60, 70, 80, 90, 100, 110, 120, 130, 140, 150, 160, 170, 180, 190, 200, 210, 220, 230, 240, 250, 260, 270, 280, 290, 300, 350, 400, 450, 500, 550, 600, 650, 700, 750, 800, 850, 900, 950, or 1000 m²/g. In some cases, an enhancer compound has a surface area (BET) of about 140-360 m²/g.

An enhancer compound may contain trace amounts of other elements. In some cases, an enhancer compound has a Fe₂O₃ (ignited product) content of about or less than about 0.03% or 0.05%. In some cases, an enhancer compound has a Al₂O₃ (ignited product) content of about or less than about 0.2%. In some cases, an enhancer compound has a Fe (beer soluble) content of less than about 2.0%. In some cases, an enhancer compound has a Ca (beer soluble) content of less than about 5.0%. In some cases, an enhancer compound has a chloride content of less than about 0.1%. In some cases, an enhancer compound has an electrolyte (as Na₂SO₄) of less than about 2.2%, 3.0%, or 0.5%. In some cases, an enhancer compound has a heavy metal content of less than about 25 ppm.

An enhancer compound may be in a dehydrated state (e.g., annealed or dried). For example, the decrease in mass upon drying of an enhancer compound can be about or up to about 1, 2, 3, 4, 5, 6, 7, 8, 9, or 10%. In some cases, an enhancer can be heated (e.g., at 105° C., 145° C., 160° C., 400° C., or 1000° C.) for at least 0.5, 1, 1.5, 2, 2.5, 3, 3.5, or 4 hours to remove moisture and dry the enhancer. In some cases, an enhancer compound has a moisture of about or less than about 1.5%, 3%, 5%, or 7% after heating at 145° C. for 4 hours; a moisture of about or less than about 4%, 6%, or 7% after heating at 105° C. for 2 hours; a maximum moisture of about 3.0% at 160° C.; a loss on drying of about or up to about 40% or 63%; a loss on drying of about 59.0-65.0% at 160° C.; or a loss on ignition of about or less than about 5%, 8.5%, or 9% after heating at 1000° C. for 1 hour.

In some cases, an enhancer compound has a pH of about 5.4, 6.8, 6.9, 7.0, 3.5-5.5, 3.5-9.0, 3.0-9.0, 6.4-7.0, 6.4-7.4, 6.0-7.6, 6.0-8.0, or 6.0-8.2 in a 5% aqueous suspension or slurry.

In some cases, an enhancer compound has an oil adsorption of about 190-280 cc/100 g or about 80 g/100 g, 200 g/100 g, or 300 g/100 g. In some cases, an enhancer compound has a dioctyl adipate adsorption (DOA) of about 248-324 cc/100 g. In some cases, an enhancer compound has a di-n-butyl phthalate (DBP) adsorption of about 190 mL/100 g, 210 mL/100 g, 230 mL/100 g, or 240 mL/100 g or greater than 185 mL/100 g.

As used herein, the term “about” can be understood as within 15%, 14%, 13%, 12%, 11%, 10%, 9%, 8%, 7%, 6%, 5%, 4%, 3%, 2%, 1%, 0.5%, 0.1%, 0.05%, or 0.01% of the stated value.

In some cases, the term “portion” can be understood as about 0.01, 0.05, 0.1, 0.5, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 91, 92, 93, 94, 95, 96, 97, 98, 99, 99, 99.1, 99.2, 99.3, 99.4, 99.5, 99.6, 99.7, 99.8, 99.9, or 100% of the referenced value; at least 0.01, 0.05, 0.1, 0.5, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 91, 92, 93, 94, 95, 96, 97, 98, 99, 99, 99.1, 99.2, 99.3, 99.4, 99.5, 99.6, 99.7, 99.8, 99.9, or 100% of the referenced value; or up to 0.01, 0.05, 0.1, 0.5, 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 91, 92, 93, 94, 95, 96, 97, 98, 99, 99, 99.1, 99.2, 99.3, 99.4, 99.5, 99.6, 99.7, 99.8, 99.9, or 100% of the referenced value.

In some cases, the term “one or more” can be understood as about 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100; at least 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100; or up to 1, 2, 3, 4, 5, 6, 7, 8, 9, 10, 11, 12, 13, 14, 15, 16, 17, 18, 19, 20, 25, 30, 35, 40, 45, 50, 55, 60, 65, 70, 75, 80, 85, 90, 95, or 100.

### Enhanced Salt Compositions

An enhanced salt composition comprises a salt and an enhancer compound. Enhanced salt compositions with enhanced salt taste may impart to foods a desired saltiness with less salt. Enhanced salt compositions may be formed by mixing a salt with one or more enhancer compounds, such as amino acids, peptides, proteins, metal oxides, chitosan, or chitin. An enhanced salt composition can be purified or isolated. An enhanced salt composition is preferably substantially uniform or homogenous. An enhanced salt composition can be in the form of a liquid (e.g., a solution, colloid, suspension, dispersion). An enhanced salt composition can be in the form of a solid (e.g., a powder, particle, granule, crystal). In some cases, an enhanced salt composition is dry and/or dehydrated.

The physical properties of an enhanced salt composition or its individual components can be characterized, for example, by elemental analysis, density, viscosity, microscopy, elemental mapping, refractive index (RI), transmission Fourier transform infrared spectroscopy (FTIR), Inductively Coupled Plasma (ICP), Thermogravimetric Analysis (TGA), dynamic light scattering (DLS), or laser diffraction. For example, enhanced salt compositions can be powders with small particle sizes. The particle sizes of an enhanced salt composition can be measured (e.g., by DLS or laser diffraction). The distribution of particle sizes can be measured by size fractionation of particles using sieves with openings of different sizes. Surface area can be measured by Brunauer-Emmett-Teller (BET) theory. Physical properties of an enhanced salt composition may affect its taste properties. For example, the perceived saltiness of an enhanced salt composition may be correlated to the distribution of particle sizes.

An enhanced salt composition may have a defined ratio of amounts of the enhancer compound and the salt. Such a ratio of amounts may be determined by mass, weight, volume, or mole. In some cases, a ratio of an enhancer compound to a salt may be at least 0.05%, 0.1%, 0.15%, 0.2%, 0.25%, 0.3%, 0.35%, 0.4%, 0.45%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.5%, 6.0%, 6.5%, 7.0%, 7.5%, 8.0%, 8.5%, 9.0%, 9.5%, or 10.0%. In some cases, a ratio of an enhancer compound to a salt may be up to 0.05%, 0.1%, 0.15%, 0.2%, 0.25%, 0.3%, 0.35%, 0.4%, 0.45%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.5%, 6.0%, 6.5%, 7.0%, 7.5%, 8.0%, 8.5%, 9.0%, 9.5%, or 10.0%. In some cases, a ratio of an enhancer compound to a salt may be about 0.05%, 0.1%, 0.15%, 0.2%, 0.25%, 0.3%, 0.35%, 0.4%, 0.45%, 0.5%, 0.6%, 0.7%, 0.8%, 0.9%, 1.0%, 1.1%, 1.2%, 1.3%, 1.4%, 1.5%, 1.6%, 1.7%, 1.8%, 1.9%, 2.0%, 2.1%, 2.2%, 2.3%, 2.4%, 2.5%, 2.6%, 2.7%, 2.8%, 2.9%, 3.0%, 3.1%, 3.2%, 3.3%, 3.4%, 3.5%, 3.6%, 3.7%, 3.8%, 3.9%, 4.0%, 4.1%, 4.2%, 4.3%, 4.4%, 4.5%, 4.6%, 4.7%, 4.8%, 4.9%, 5.0%, 5.5%, 6.0%, 6.5%, 7.0%, 7.5%, 8.0%, 8.5%, 9.0%, 9.5%, or 10.0%. In some cases, a ratio of an enhancer compound to a salt may be from about 0.1-10.0%, 0.1-9.0%, 0.1-8.0%, 0.1-7.0%, 0.1-6.0%, 0.1-5.0%, 0.1-4.0%, 0.1-3.0%, 0.1-2.0%, 0.1-1.0%, 0.5-10%, 0.5-9.0%, 0.5-8.0%, 0.5-7.0%, 0.5-6.0%, 0.5-5.0%, 0.5-4.0%, 0.5-3.0%, 0.5-2.0%, 0.5-1.0%, 1.0-10.0%, 1.0-9.0%, 1.0- 8.0%, 1.0-7.0%, 1.0-6.0%, 1.0-5.0%, 1.0-4.0%, 1.0-3.0%, 1.0-2.0%, 2.0-5.0%, 2.0-4.0%, 2.0- 3.5%, or 2.0-3.0%. A ratio of an enhancer compound to a salt may be from about 0.1-10.0%.

In some cases, an enhanced salt composition described herein is acidic, neutral, or basic. In some cases, an enhanced salt composition has a pH of about or at least about 2, 2.5, 3, 3.5, 4, 4.5, 5, 5.5, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 9, 9.5, or 10. In some cases, an enhanced salt composition has a pH of up to about 2, 2.5, 3, 3.5, 4, 4.5, 5, 5.5, 6, 6.1, 6.2, 6.3, 6.4, 6.5, 6.6, 6.7, 6.8, 6.9, 7, 7.1, 7.2, 7.3, 7.4, 7.5, 7.6, 7.7, 7.8, 7.9, 8, 8.1, 8.2, 8.3, 8.4, 8.5, 9, 9.5, or 10. In some cases, an enhanced salt composition may have a pH within the range from about 2 to about 8, from about 4 to about 8, from about 6 to about 8, or from about 7 to about 8.5.

An enhanced salt composition may have enhanced saltiness compared to a control composition. Preferably, the control composition is the salt but not the enhancer compound of the enhanced salt composition to which it is compared. The enhanced salt composition may have a quantified enhanced saltiness. Such enhanced saltiness may be determined by a sensory test. Examples of sensory taste tests are described herein.

In some instances, an enhanced salt composition can have the saltiness enhanced by at least 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control composition. The enhanced salt composition can have the saltiness enhanced by up to 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control composition. The enhanced salt composition can have the saltiness enhanced by about 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control composition. For example, the saltiness can be enhanced by 10-100%, 20-80%, or 30-60% relative to a control composition.

An enhanced salt composition may have enhanced umami or savoriness compared to a control composition. Preferably, the control composition is the salt but not the enhancer compound of the enhanced salt composition to which it is compared. The enhanced salt composition may have a quantified enhanced umami or savoriness. Such enhanced umami or savoriness may be determined by a sensory test. Examples of sensory taste tests are described herein.

In some instances, an enhanced salt composition can have the umami or savoriness enhanced by at least 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control composition. The enhanced salt composition can have the umami or savoriness enhanced by up to 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control composition. The enhanced salt composition can have the umami or savoriness enhanced by about 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control composition. For example, the umami or savoriness can be enhanced by 10-100%, 20-80%, or 30-60% relative to a control composition. In some cases, an enhanced salt composition with an enhanced umami or savoriness comprises a glutamate salt (e.g., monosodium glutamate), guanylate salt (e.g., disodium guanylate), or inosinate salt (e.g., disodium inosinate). In some cases, an enhanced salt composition with an enhanced umami or savoriness comprises glycine.

In some cases, a salt in an enhanced salt composition is sodium chloride. In some cases, an enhancer compound in an enhanced salt composition is glycine. In some cases, an enhanced salt composition comprises sodium chloride and glycine. In some cases, an enhancer compound in an enhanced salt composition is silicon dioxide. In some cases, an enhanced salt composition comprises sodium chloride and silicon dioxide. In some cases, an enhancer compound in an enhanced salt composition is chitosan. In some cases, an enhanced salt composition comprises sodium chloride and chitosan. In some cases, an enhancer compound in an enhanced salt composition is chitin. In some cases, an enhanced salt composition comprises sodium chloride and chitin. In some cases, an enhancer compound in an enhanced salt composition is a peptide. In some cases, an enhanced salt composition comprises sodium chloride and a peptide.

### Methods of Making Enhanced Salt Compositions

In one instance, a method of producing an enhanced salt composition comprises mixing a salt with an enhancer compound. The salt and enhancer compound can be added simultaneously or sequentially in any order. The salt and enhancer compound can be dissolved in a solvent or mixed as solids. In some cases, a source of a salt comprises a salt dissolved in a solvent, for example, a sauce (e.g., fish sauce, soy sauce, spaghetti sauce, tomato sauce) or a dressing. An enhancer compound can be added to the source of the salt.

The mixing can be accomplished by one or more methods including stirring, homogenizing, sonicating, grinding, compressing, blending, agitating, rotational mixing, solid-solid mixing with a static mixer, mortar and pestle, Kenics mixing, drum tumbling, and Turbula mixing.

During mixing, one or more reaction parameters such as temperature, concentration, stoichiometry, order of mixing, mixing speed, and mixing time can be adjusted. Adjusting one or more reaction parameters may affect intermolecular structure, electrostatic interactions, bulk density, proximity between the different components, and/or particle size of the enhanced salt composition that is formed.

An enhanced salt composition may be formulated as a solution. In some cases, the concentration of salt in solvent is about or at least 5%, 10%, 15%, 20%, 25%, 30%, 35%, 40%, 45%, 50%, 55%, 60%, 65%, 70%, 75%, 80%, 85%, 90%, 95%, or 100%. In some cases, the concentration of salt in solvent is up to 5%, 10%, 15%, 20%, 25%, 30%, 35%, 40%, 45%, 50%, 55%, 60%, 65%, 70%, 75%, 80%, 85%, 90%, 95%, or 100%. In some cases, the concentration of salt in solvent is about 10-50%, 10-40%, 10-30%, 20-50%, 20-40%, 20-30%, or 20-25%. In some cases, mixing or dissolving in a solvent may occur at a temperature of up to 25, 30, 35, 40, 45, 50, 55, 60, 65, 70, 75, 80, 85, 90, 95, or 100° C. In some cases, mixing or dissolving in a solvent may occur at room temperature.

The pH of a solution can be adjusted. In some cases, the pH of a solution may be about or at least 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0. In some cases, the pH of a solution may be up to 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9, 4.0, 4.1, 4.2, 4.3, 4.4, 4.5, 4.6, 4.7, 4.8, 4.9, 5.0, 5.1, 5.2, 5.3, 5.4, 5.5, 5.6, 5.7, 5.8, 5.9, 6.0, 6.1, 6.2, 6.3, 6.4, 6.5, 6.6, 6.7, 6.8, 6.9, 7.0, 7.1, 7.2, 7.3, 7.4, 7.5, 7.6, 7.7, 7.8, 7.9, 8.0, 8.1, 8.2, 8.3, 8.4, 8.5, 8.6, 8.7, 8.8, 8.9, 9.0, 9.1, 9.2, 9.3, 9.4, 9.5, 9.6, 9.7, 9.8, 9.9, or 10.0. In some cases, the pH of a solution may be between about 2.0-10.0, 2.0-9.0, 2.0-8.0, 2.0-7.0, 2.0-6.0, 2.0-5.0, 2.0-4.0, 3.0-10.0, 4.0-10.0, 5.0-10.0, 6.0-10.0, 7.0-10.0, 8.0-10.0, 9.0-10.0, 3.0-9.0, 4.0-9.0, 5.0-9.0, 6.0-9.0, 7.0-9.0, 8.0-9.0, 3.0-8.0, 3.0-7.0, 3.0-6.0, 3.0-5.0, 3.0-4.0, 6.0-8.0, 6.0-7.0, or 7.0-8.0.

A method of making an enhanced salt composition may comprise drying. In some cases, drying forms a dry and/or dehydrated enhanced salt composition. In some cases, drying forms a solid enhanced salt composition. Non-limiting examples of drying methods include crystallization, thermal drying, evaporation, distillation, boiling, heating in an oven, vacuum drying, spray drying, freeze drying, and lyophilization. The mechanism of drying can affect the hydration and molecular structure of the enhanced salt composition and give rise to enhanced salt compositions with different physical properties. In some cases, an enhanced salt composition can be dried until the composition comprises up to 0.001, 0.005, 0.01, 0.05, 0.1, 0.2, 0.3, 0.4, 0.5, 0.6, 0.7, 0.8, 0.9, 1.0, 1.5, 2, 2.5, 3, 3.5, 4, 4.5, 5, 6, 7, 8, 9, or 10% water by weight. In some cases, an enhanced salt composition can be dried until the composition comprises at least 0.001, 0.005, 0.01, 0.05, 0.1, 0.2, 0.3, 0.4, 0.5, 0.6, 0.7, 0.8, 0.9, 1.0, 1.5, 2, 2.5, 3, 3.5, 4, 4.5, 5, 6, 7, 8, 9, or 10% water by weight. In some cases, an enhanced salt composition can be dried until the composition comprises about 0.001, 0.005, 0.01, 0.05, 0.1, 0.2, 0.3, 0.4, 0.5, 0.6, 0.7, 0.8, 0.9, 1.0, 1.5, 2, 2.5, 3, 3.5, 4, 4.5, 5, 6, 7, 8, 9, or 10% water by weight. For example, an enhanced salt composition can be dried via any standard drying method (e.g., 12-80 hours in an oven at 60° C., using industrial air blowers, etc.) to form a dry solid enhanced salt composition.

A method of making an enhanced salt composition may comprise mechanical mixing or grinding. An enhanced salt composition, salt, and/or enhancer compound can be mixed or ground by one or more mechanical methods. Non-limiting examples of mechanical methods include stirring, homogenizing, sonicating, grinding, compressing, blending, agitating, rotational mixing, solid-solid mixing with a static mixer, mortar and pestle, Kenics mixing, drum tumbling, and Turbula mixing. In some cases, two or more forms of mechanical methods can be used in series or in parallel. For example, an enhanced salt composition can be ground mechanically in a grinder and subsequently further ground mechanically via mortar and pestle. The conditions of the mechanical coating or grinding (e.g., temperature, time duration, speed, timing, rate, force, pressure, etc.) can affect the saltiness of the resulting composition. These conditions may be selected to give the largest enhancement of saltiness to the resulting composition. In some cases, mixing or grinding may be carried out for at least 0.1, 0.2, 0.3, 0.4, 0.5, 1, 2, 3, 4, 5, 6, 7, 8, 9, 10, 11, 12, 13, 14, 15, 16, 17, 18, 19, or 20 minutes. In some cases, mixing or grinding may be carried out for up to 0.1, 0.2, 0.3, 0.4, 0.5, 1, 2, 3, 4, 5, 6, 7, 8, 9, 10, 11, 12, 13, 14, 15, 16, 17, 18, 19, or 20 minutes. In some cases, mixing or grinding may be carried out for about 0.1, 0.2, 0.3, 0.4, 0.5, 1, 2, 3, 4, 5, 6, 7, 8, 9, 10, 11, 12, 13, 14, 15, 16, 17, 18, 19, or 20 minutes. In some cases when two or more forms of mechanical methods are used in series or in parallel, the timing and conditions of each form can be selected independently.

A method of making an enhanced salt composition may comprise sonicating and/or homogenizing. An enhanced salt composition, salt, and/or enhancer compound can be subjected to sonication and/or homogenizing. In some cases, the sonication or homogenizing can be for up to 1, 2, 3, 4, 5, 6, 7, 8, 9, 10, 11, 12, 13, 14, 15, 16, 17, 18, 19, 20, 24, 30, 40, 50, or 60 minutes. In some cases, the sonication or homogenizing can be for at least 1, 2, 3, 4, 5, 6, 7, 8, 9, 10, 11, 12, 13, 14, 15, 16, 17, 18, 19, 20, 24, 30, 40, 50, or 60 minutes. In some cases, the sonication or homogenizing can be for about 1, 2, 3, 4, 5, 6, 7, 8, 9, 10, 11, 12, 13, 14, 15, 16, 17, 18, 19, 20, 24, 30, 40, 50, or 60 minutes. The sonication or homogenizing may occur with heating. In some cases, the sonication or homogenizing may occur at a temperature of up to 25, 30, 35, 40, 45, 50, 55, 60, 65, 70, 75, 80, 85, 90, 95, or 100° C. In some cases, the sonication or homogenizing may occur at a temperature of at least 25, 30, 35, 40, 45, 50, 55, 60, 65, 70, 75, 80, 85, 90, 95, or 100° C. In some cases, the sonication or homogenizing may occur at a temperature of around 25, 30, 35, 40, 45, 50, 55, 60, 65, 70, 75, 80, 85, 90, 95, or 100° C. In some cases, the sonication or homogenizing may occur at room temperature. In some cases, the sonication may occur at a frequency of about or at least 5, 6, 7, 8, 9, 10, 11, 12, 13, 14, 15, 16, 17, 18, 19, 20, 25, 30, 35, 40, 45, 50, 55, 60, 65, 70, 75, or 80 kHz. In some cases, sonication may be performed in a bath sonicator or using a probe sonicator. In some cases, homogenization may be performed in a homogenizer, rotor-stator homogenizer, high-shear mixer (e.g., batch high-shear mixer, inline high-shear mixer, inline powder induction, high-shear granulator, ultra-high-shear inline mixer, high speed disperser, solids injection, high shear rotor-stator mixer, in-tank mixer). In some cases, the sonication or homogenizing occurs during grinding or mixing. In some cases, the enhanced salt composition is sonicated and/or homogenized. In some cases, the enhanced salt composition is not sonicated or homogenized.

A method of making an enhanced salt composition may comprise filtering and/or sieving. An enhanced salt composition, salt, and/or enhancer compound can be passed through a sieve or sieving tower to remove particles of particular sizes, of at least a minimum size, of at most a maximum size, or of at least a minimum size and at most a maximum size from the composition. In some cases, the sieve can have a mesh with openings up to 30, 40, 50, 60, 70, 80, 90, 100, 110, 120, 130, 140, 150, 160, 170, 180, 190, or 200 mesh. In some cases, the sieve can have a mesh with openings of at least 30, 40, 50, 60, 70, 80, 90, 100, 110, 120, 130, 140, 150, 160, 170, 180, 190, or 200 mesh. In some cases, the sieve can have a mesh with openings around 30, 40, 50, 60, 70, 80, 90, 100, 110, 120, 130, 140, 150, 160, 170, 180, 190, or 200 mesh. In some cases, the sieve can have a mesh with openings of about 40 to about 100 mesh. The sieve can have a mesh with openings of about 60 to about 70 mesh.

### Applications of Salt Compositions

An enhanced salt composition provided herein may be used as a seasoning, flavoring, or salt substitute. An enhanced salt composition provided herein may be used as a seasoning or flavoring for a consumable product. An enhanced salt composition provided herein may be used as a salt substitute for a consumable product. A consumable product may comprise a composition provided herein. Non-limiting examples of a consumable product include food products.

A method of producing a consumable product with enhanced saltiness, lower salt content, lower sodium value, or any combination thereof may comprise adding an enhanced salt composition to the consumable product or substituting a portion of one or more salt ingredients in the consumable product with an enhanced salt composition. In some cases, a consumable product may comprise one or more modifying components that allow for incorporation of the enhanced salt composition.

In some cases, an enhanced salt composition described herein can be added to or substituted into (e.g., by replacing a portion of one or more salt ingredients in the consumable product) a consumable product to produce at least 1, 2, 3, 4, or 5; up to 1, 2, 3, 4, or 5; or about 1, 2, 3, 4, or 5 of the characteristics selected from the group consisting of increased saltiness, reduction of salt used while maintaining saltiness sensation, reduction of sodium used while maintaining saltiness sensation, reduced salt value, and reduced sodium value of the consumable product. The characteristic of the consumable product comprising the enhanced salt composition can be compared to a control product that does not have the enhanced salt composition added to it or substituted into it. For example, a consumable product with an added or substituted enhanced salt composition can have one or more of the characteristics enhanced by at least 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control product. In some cases, a consumable product with an added or substituted enhanced salt composition can have one or more of the characteristics enhanced by up to 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control product. In some cases, a consumable product with an added or substituted enhanced salt composition can have one or more of the characteristics enhanced by about 5%, 10%, 20%, 30%, 40%, 50%, 60%, 70%, 80%, 90%, 100%, 110%, 120%, 130%, 140%, 150%, 160%, 170%, 180%, 190%, 200%, 210%, 220%, 230%, 240%, 250%, 260%, 270%, 280%, 290%, or 300% relative to a control product. For example, the saltiness can be enhanced by 10-100%, 20-80%, or 30-60% relative to a control product.

### Sensory Testing

Enhanced saltiness can be determined by a sensory test. Equivalent saltiness with a lower salt content or lower sodium value can be determined by a sensory test. The sensory test may be a taste test. The sensory test may be a blind test. One non-limiting example of a taste test method to measure enhanced saltiness is to taste a set amount of a control composition, and then taste varying amounts of the enhanced salt composition to find the amount of enhanced salt composition that corresponds to the saltiness of the control composition. The enhanced saltiness can be calculated by the following formula: [amount of control composition—amount of enhanced salt composition required for equal saltiness]/[amount of control composition]. For example, varying amounts of an enhanced salt composition described herein (e.g., 5, 4, 3, 2 and 1 mg of a composition comprising sodium chloride and 1% glycine) are tasted to find an equal saltiness to a control composition (e.g., 5 mg sodium chloride). In this case, if the test shows that 3 mg of the enhanced salt composition has an equivalent saltiness to 5 mg of the control composition, then the enhanced saltiness is calculated as (5-3)/5=40%.

A sensory test can use one or more various protocols. For example, a sensory test can be the “triangle method”, follow ISO requirements, or a combination thereof. The taste test can be the average of multiple trials. For example, each taste tester can consume multiple enhanced salt compositions or foods, or consumable products comprising an enhanced salt composition and sequence them by relative saltiness. A taste test can comprise tasting a standard and determining whether a tested composition is more or less salty than the standard.

A taste test may be a screening test, a professional taste test, or a market research test. A screening test may be performed by at least 1, 2, 3, 4, 5, 6, 7, 8, or 9 taste testers. A professional taste test may be performed by at least 10, 15, 20, 25, or 30 taste testers. A market research test may be performed by at least 31, 40, 50, 60, 70, 80, 90, 100, 150, 200, 300, 400, or 500 taste testers. A taste tester can be a person with average taste perception. A taste tester can be a professional taste tester. A taste tester can be a person who has passed a tasting exam by correctly identifying foods or food components. A taste tester can be a person who can identify the relative amounts of a taste or flavor (e.g., correctly sequence varying amounts of sodium chloride in water).

### EXAMPLES

### Example 1

### Formation of an Enhanced Salt Composition Comprising Glycine from Solids

Sodium chloride and glycine, or sodium chloride by itself for the tasting control composition, are ground together in the amounts listed in Table 1 in a Moulinex grinder for 20 seconds. The mixture is further ground mechanically by mortar and pestle for 10 minutes. The mixture is sonicated at 40 kHz at 40° C. for 30 minutes. The mixture is sieved at 200 microns.

TABLE 1

| | Sodium chloride | Glycine |
|---|---|---|
| Description | [g ± 0.1 mg] | [g ± 0.1 mg] |
| Sodium chloride with 0.1% glycine | 20.0050 | 0.0206 |
| Sodium chloride with 0.5% glycine | 20.0003 | 0.1003 |
| Sodium chloride with 1% glycine | 20.0044 | 0.2002 |
| Sodium chloride with 2% glycine | 10.0179 | 0.2036 |
| Sodium chloride with 3.5% glycine | 20.0276 | 0.7090 |
| Sodium chloride with 5% glycine | 10.0153 | 0.5064 |
| Sodium chloride with 10% glycine | 10.0131 | 1.0060 |

### Example 2

### Tasting of Enhanced Salt Compositions Comprising Glycine

Each taster is given 4 mg of each sample. Tasting results are ranked in Table 2 based on salty sensation.

TABLE 2

| | Sodium | | |
|---|---|---|---|
| | chloride | Sodium chloride with | Sodium chloride with |
| | control | 5% glycine | 10% glycine |
| Taster 1 | X | X + 1.5 | X + 1.5 |
| Taster 2 | X | X + 1 | X + 1.5 |
| Taster 3 | X | X + 1 | X + 2 |
| Average | X | X + 1.16 | X + 1.67 |

Key:
X represents a level of salty sensation,
X + 1 represents a taste that is saltier than X,
X + 1.5 represents a taste that is saltier than X + 1,
X + 2 represents a taste that is saltier than X + 1.5

### Example 3

### Tasting of Enhanced Salt Compositions Comprising Glycine

Each taster is given 2 mg of each sample. Tasting results are ranked in Table 3 based on salty sensation.

TABLE 3

| | | Sodium | Sodium | |
|---|---|---|---|---|
| | Sodium | chloride | chloride | |
| | chloride | with 5% | with 10% | Sodium chloride with 5% |
| | control | glycine | glycine | glycine (repeated tasting) |
| Taster 1 | X | X + 1.5 | X + 1 | X + 1 |
| Taster 2 | X | X + 1 | X + 0.5 | X + 1 |
| Taster 3 | X | X + 2.5 | X + 2 | X + 2.5 |
| Taster 4 | X | X + 0.5 | X + 1.5 | X + 1 |
| Average | X | X + 1.38 | X + 1.25 | X + 1.38 |

Key:
X represents a level of salty sensation,
X + 0.5 represents a taste that is saltier than X,
X + 1 represents a taste that is saltier than X + 0.5,
X + 1.5 represents a taste that is saltier than X + 1,
X + 2 represents a taste that is saltier than X + 1.5,
X + 2.5 represents a taste that is saltier than X + 2

### Example 4

### Tasting of Enhanced Salt Compositions Comprising Glycine

Each taster is given 2 mg of each sample. Tasting results are ranked in Table 4 based on salty sensation.

TABLE 4

| | Sodium | | | Sodium |
|---|---|---|---|---|
| | chloride | Sodium chloride | Sodium chloride | chloride with |
| | control | with 0.1% glycine | with 0.5% glycine | 1% glycine |
| Taster 1 | X | X | X + 0.75 | X + 0.5 |
| Taster 2 | X | X + 0.5 | X + 0.75 | X |
| Taster 3 | X | X + 0.5 | X − 0.5 | X |
| Average | X | X + 0.33 | X + 0.33 | X + 0.17 |

Key:
X represents a level of salty sensation,
X + 0.5 represents a taste that is saltier than X,
X + 0.75 represents a taste that is saltier than X + 0.5,
X + 1 represents a taste that is saltier than X + 0.75,
X + 1.5 represents a taste that is saltier than X + 1,
X + 2 represents a taste that is saltier than X + 1.5,
X − 0.5 represents a taste that is less salty than X

### Example 5

### Tasting of Enhanced Salt Compositions Comprising Glycine

Each taster is given 3 mg of each sample. Tasting results are ranked in Table 5 based on salty sensation.

TABLE 5

| | | | | | Sodium |
|---|---|---|---|---|---|
| | Sodium | Sodium | Sodium | Sodium | chloride |
| | chloride | chloride with | chloride with | chloride with | with 5% |
| | control | 1% glycine | 2% glycine | 3.5% glycine | glycine |
| Taster 1 | X | X + 1 | X + 2 | X + 2 | X + 0.5 |
| Taster 2 | X | X + 0.5 | X + 0.75 | X | X − 0.5 |
| Taster 3 | X | X + 1 | X + 1.5 | X + 1 | X + 0.5 |
| Taster 4 | X | X + 1 | X + 1.5 | X + 1 | X + 0.5 |
| Average | X | X + 0.88 | X + 1.44 | X + 1 | X + 0.25 |

Key:
X represents a level of salty sensation,
X + 0.5 represents a taste that is saltier than X
X + 0.75 represents a taste that is saltier than X + 0.5,
X + 1 represents a taste that is saltier than X + 0.75,
X + 1.5 represents a taste that is saltier than X + 1,
X + 2 represents a taste that is saltier than X + 1.5,
X + 2.5 represents a taste that is saltier than X + 2,
X − 0.5 represents a taste that is less salty than X

### Example 6

### Formation of an Enhanced Salt Composition Comprising Glycine from Solution

Sodium chloride is dissolved in deionized water to form a 25% sodium chloride w/w solution. Various amounts of glycine, listed in Table 6, are added to form solutions with varying glycine percentages relative to the sodium chloride content. The solution is mixed for 10 minutes. In some embodiments, the solution is further sonicated and/or homogenized.

TABLE 6

| | Deionized water | Sodium chloride | Glycine |
|---|---|---|---|
| Description | [g ± 0.01 g] | [g ± 0.01 g] | [g ± 0.1 mg] |
| 25% Sodium chloride with 0.25% | 375.00 | 125.01 | 0.3123 |
| glycine relative to sodium chloride | | | |
| 25% Sodium chloride with 2% glycine | 375.00 | 125.01 | 2.5010 |
| relative to sodium chloride | | | |
| 25% Sodium chloride with 3% glycine | 375.00 | 125.01 | 3.7506 |
| relative to sodium chloride | | | |

### Example 7

### Tasting of Liquid Enhanced Salt Compositions Comprising Glycine

Each taster is given 15 μL of each sample, as well as 15 μL of a 25% sodium chloride solution as a control. Tasting results are ranked in Table 7 based on salty sensation.

TABLE 7

| | 25% Sodium | 25% Sodium | 25% Sodium | 25% Sodium |
|---|---|---|---|---|
| | chloride | chloride with | chloride with | chloride with |
| | control | 0.25% glycine | 2% glycine | 3% glycine |
| Taster 1 | X | X + 0.65 | X + 0.6 | X + 1.5 |
| Taster 2 | X | X + 0.37 | X + 0.25 | X + 0.37 |
| Taster 3 | X | X + 0.6 | X + 0.7 | X + 0.6 |
| Average | X | X + 0.54 | X + 0.52 | X + 0.82 |

Key:
X represents a level of salty sensation,
X + 0.25 represents a taste that is saltier than X,
X + 0.37 represents a taste that is saltier than X + 0.25,
X + 0.6 represents a taste that is saltier than X + 0.37,
X + 0.65 represents a taste that is saltier than X + 0.6,
X + 0.7 represents a taste that is saltier than X + 0.65,
X + 1.5 represents a taste that is saltier than X + 0.7

### Example 8

### Tasting Dried Samples of Enhanced Salt Composition Comprising Glycine from Solution

Liquid samples containing 25% sodium chloride and 0.25%, 2%, or 3% glycine were dried and tasted against dried 25% sodium chloride solution as a control. Tasting results are ranked in Table 8 based on salty sensation.

TABLE 8

| | | Dried 25% | Dried 25% | Dried 25% |
|---|---|---|---|---|
| | | sodium | sodium | sodium |
| | Dried 25% | chloride | chloride | chloride |
| | sodium chloride | with 0.25% | with 2% | with 3% |
| | control | glycine | glycine | glycine |
| Taster 1 | X | X + 0.6 | X + 0.7 | X + 0.5 |
| Taster 2 | X | X | X + 0.15 | X + 0.3 |
| Taster 3 | X | X + 0.3 | X + 0.6 | X + 0.6 |
| Average | X | X + 0.3 | X + 0.48 | X + 0.47 |

Key:
X represents a level of salty sensation,
X + 0.15 represents a taste that is saltier than X,
X + 0.3 represents a taste that is saltier than X + 0.15,
X + 0.5 represents a taste that is saltier than X + 0.3,
X + 0.6 represents a taste that is saltier than X + 0.5,
X + 0.7 represents a taste that is saltier than X + 0.6

### Example 9

### Formation of an Enhanced Salt Composition Comprising Silicon Dioxide

Sodium chloride is dissolved in deionized water to form a 20% sodium chloride w/w solution. Various amounts of silicon dioxide (for example, Perkasil SM660®), listed in Table 9, are added to form solutions with varying silicon dioxide percentages relative to the sodium chloride content. The solution is mixed vigorously for 1.5 hours. In some embodiments, the solution is further sonicated and/or homogenized.

TABLE 9

| | 20% sodium | |
|---|---|---|
| | chloride solution | Silicon dioxide |
| Description | [g ± 0.01 g] | [g ± 0.1 mg] |
| 20% Sodium chloride with 0.25% | 50.00 | 0.0251 |
| silicon dioxide relative to sodium | | |
| chloride | | |
| 20% Sodium chloride with 0.5% | 50.00 | 0.0503 |
| silicon dioxide relative to sodium | | |
| chloride | | |

### Example 10

### Tasting of Liquid Enhanced Salt Compositions Comprising Silicon Dioxide

Each taster is given 15 μL of each sample, as well as 15 μL of a 25% sodium chloride solution as a control. Tasting results are ranked in Table 10 based on salty sensation.

TABLE 10

| | | 20% Sodium | 20% Sodium |
|---|---|---|---|
| | 20% Sodium | chloride with | chloride with |
| | chloride control | 0.25% silicon dioxide | 0.5% silicon dioxide |
| Taster 1 | X | X + 0.6 | X + 0.9 |
| Taster 2 | X | X + 0.6 | X + 0.3 |
| Taster 3 | X | X | X |
| Taster 4 | X | X + 0.1 | X + 0.7 |
| Taster 5 | X | X + 0.6 | X + 0.3 |
| Average | X | X + 0.38 | X + 0.44 |

Key:
X represents a level of salty sensation,
X + 0.1 represents a taste that is saltier than X,
X + 0.3 represents a taste that is saltier than X + 0.1,
X + 0.6 represents a taste that is saltier than X + 0.3,
X + 0.7 represents a taste that is saltier than X + 0.6,
X + 0.9 represents a taste that is saltier than X + 0.7

### Example 11

### Formation of an Enhanced Salt Composition Comprising Silicon Dioxide from Solids

Sodium chloride and silicon dioxide, or sodium chloride by itself for the tasting control composition, are ground together at 0.1%, 0.25%, 0.5%, 1%, 2%, 3%, 3.5%, 5%, or 8% silicon dioxide weight/weight relative to sodium chloride in a Moulinex grinder for 20 seconds. The mixture is further ground mechanically by mortar and pestle for 10 minutes. The mixture is sonicated at 40 kHz at 40° C. for 30 minutes. The mixture is sieved at 200 microns.

### Example 12

### Formation of an Enhanced Salt Composition Comprising Chitosan from Solids

Sodium chloride and chitosan, or sodium chloride by itself for the tasting control composition, are ground together at 0.1%, 0.25%, 0.5%, 1%, 2%, 3%, 3.5%, 5%, or 10% chitosan weight/weight relative to sodium chloride in a Moulinex grinder for 20 seconds. The mixture is further ground mechanically by mortar and pestle for 10 minutes. The mixture is sonicated at 40 kHz at 40° C. for 30 minutes. The mixture is sieved at 200 microns.

### Example 13

### Formation of an Enhanced Salt Composition Comprising Chitosan from Solution

Sodium chloride is dissolved in deionized water to form a 25% sodium chloride w/w solution. Various amounts of chitosan are added to form solutions with 0.1%, 0.25%, 0.5%, 1%, 2%, 3%, 3.5%, 5%, or 10% chitosan weight/weight relative to sodium chloride. The solution is mixed for 10 minutes. In some embodiments, the solution is further sonicated and/or homogenized. In some embodiments, the solution is further dried to form a dried enhanced salt composition.

### Example 14

### Formation of an Enhanced Salt Composition Comprising Chitin from Solids

Sodium chloride and chitin, or sodium chloride by itself for the tasting control composition, are ground together at 0.1%, 0.25%, 0.5%, 1%, 2%, 3%, 3.5%, 5%, or 10% chitin weight/weight relative to sodium chloride in a Moulinex grinder for 20 seconds. The mixture is further ground mechanically by mortar and pestle for 10 minutes. The mixture is sonicated at 40 kHz at 40° C. for 30 minutes. The mixture is sieved at 200 microns.

### Example 15

### Formation of an Enhanced Salt Composition Comprising Chitin from Solution

Sodium chloride is dissolved in deionized water to form a 25% sodium chloride w/w solution. Various amounts of chitin are added to form solutions with 0.1%, 0.25%, 0.5%, 1%, 2%, 3%, 3.5%, 5%, or 10% chitin weight/weight relative to sodium chloride. The solution is mixed for 10 minutes. In some embodiments, the solution is further sonicated and/or homogenized. In some embodiments, the solution is further dried to form a dried enhanced salt composition.

### Example 16

### Formation of an Enhanced Salt Composition Comprising a Peptide from Solids

Sodium chloride and Glu-Glu-Leu peptide, or sodium chloride by itself for the tasting control composition, are ground together at 0.1%, 0.25%, 0.5%, 1%, 2%, 3%, 3.5%, 5%, or 10% Glu-Glu-Leu peptide weight/weight relative to sodium chloride in a Moulinex grinder for 20 seconds. The mixture is further ground mechanically by mortar and pestle for 10 minutes. The mixture is sonicated at 40 kHz at 40° C. for 30 minutes. The mixture is sieved at 200 microns.

### Example 17

### Formation of an Enhanced Salt Composition Comprising a Peptide from Solution

Sodium chloride is dissolved in deionized water to form a 25% sodium chloride w/w solution. Various amounts of Glu-Glu-Leu peptide are added to form solutions with 0.1%, 0.25%, 0.5%, 1%, 2%, 3%, 3.5%, 5%, or 10% Glu-Glu-Leu peptide weight/weight relative to sodium chloride. The solution is mixed for 10 minutes. In some embodiments, the solution is further sonicated and/or homogenized. In some embodiments, the solution is further dried to form a dried enhanced salt composition.

### Example 18

### Formation of an Enhanced Salt Composition Comprising Glycine from Soy Sauce

Soy sauce is concentrated to form a 25% sodium chloride w/w solution. Various amounts of glycine are added to form solutions with 0.1%, 0.25%, 0.5%, 1%, 2%, 3%, 3.5%, 5%, or 10% glycine weight/weight relative to sodium chloride. The solution is mixed for 10 minutes. In some embodiments, the solution is further sonicated and/or homogenized. In some embodiments, the solution is further dried to form a dried enhanced salt composition.

### Example 19

### Formation of an Enhanced Salt Composition Comprising Glycine and Potassium Chloride from Solids

Potassium chloride and glycine, or potassium chloride by itself for the tasting control composition, are ground together at 0.1%, 0.25%, 0.5%, 1%, 2%, 3%, 3.5%, 5%, or 10% glycine weight/weight relative to potassium chloride in a Moulinex grinder for 20 seconds. The mixture is further ground mechanically by mortar and pestle for 10 minutes. The mixture is sonicated at 40 kHz at 40° C. for 30 minutes. The mixture is sieved at 200 microns.

### Example 20

### Formation of an Enhanced Salt Composition Comprising Glycine and Potassium Chloride from Solution

Potassium chloride is dissolved in deionized water to form a 25% potassium chloride w/w solution. Various amounts of glycine are added to form solutions with 0.1%, 0.25%, 0.5%, 1%, 2%, 3%, 3.5%, 5%, or 10% glycine weight/weight relative to potassium chloride. The solution is mixed for 10 minutes. In some embodiments, the solution is further sonicated and/or homogenized. In some embodiments, the solution is further dried to form a dried enhanced salt composition.

### Example 21

### Formation of an Enhanced Salt Composition Comprising Glycine and Disodium Guanylate from Solids

Disodium guanylate and glycine, or disodium guanylate by itself for the tasting control composition, are ground together at 0.1%, 0.25%, 0.5%, 1%, 2%, 3%, 3.5%, 5%, or 10% glycine weight/weight relative to disodium guanylate in a Moulinex grinder for 20 seconds. The mixture is further ground mechanically by mortar and pestle for 10 minutes. The mixture is sonicated at 40 kHz at 40° C. for 30 minutes. The mixture is sieved at 200 microns.

### Example 22

### Formation of an Enhanced Salt Composition Comprising Glycine and Disodium Guanylate from Solution

Disodium guanylate is dissolved in deionized water to form a 25% disodium guanylate w/w solution. Various amounts of glycine are added to form solutions with 0.1%, 0.25%, 0.5%, 1%, 2%, 3%, 3.5%, 5%, or 10% glycine weight/weight relative to disodium guanylate. The solution is mixed for 10 minutes. In some embodiments, the solution is further sonicated and/or homogenized. In some embodiments, the solution is further dried to form a dried enhanced salt composition.

### Example 23

### Formation of an Enhanced Salt Composition Comprising Glycine and Disodium Inosinate from Solids

Disodium inosinate and glycine, or disodium inosinate by itself for the tasting control composition, are ground together at 0.1%, 0.25%, 0.5%, 1%, 2%, 3%, 3.5%, 5%, or 10% glycine weight/weight relative to disodium inosinate in a Moulinex grinder for 20 seconds. The mixture is further ground mechanically by mortar and pestle for 10 minutes. The mixture is sonicated at 40 kHz at 40° C. for 30 minutes. The mixture is sieved at 200 microns.

### Example 24

### Formation of an Enhanced Salt Composition Comprising Glycine and Disodium Inosinate from Solution

Disodium guanylate is dissolved in deionized water to form a 25% disodium inosinate w/w solution. Various amounts of glycine are added to form solutions with 0.1%, 0.25%, 0.5%, 1%, 2%, 3%, 3.5%, 5%, or 10% glycine weight/weight relative to disodium inosinate. The solution is mixed for 10 minutes. In some embodiments, the solution is further sonicated and/or homogenized. In some embodiments, the solution is further dried to form a dried enhanced salt composition.

### Example 25

### Using an Enhanced Salt Composition in a Soup

Liquid vegetable stock is divided to 4 samples with a volume of 100 mL each. To each of the samples is added one of the following:
a) 1.48 g 25% sodium chloride solution (0.37 g sodium chloride) to form Sample A
b) 1.48 g 25% sodium chloride solution with 3% glycine (˜0.37 g enhanced salt composition) to form Sample B
   Samples are stirred for 10 minutes and then tasted. Tasting results are ranked in Table 11 based on salty sensation.

TABLE 11

| | Sample A - Control | Sample B |
|---|---|---|
| Taster 1 | X | Saltier |
| Taster 2 | X | Saltier |
| Taster 3 | X | Same as control |

### Example 26

### Sensory Test Procedure

The tests are participated by a panel of taste testers who have been sensory tested in the past. All participants have been trained. The tests are divided into the following 3 segments:

a) Testing the tasters sensory threshold

b) Calibration

c) Sodium chloride control composition versus enhanced salt composition tastings

Sensory threshold: Panel participants are given three reference samples of control composition, consisting of 4, 3, and 2 mg solid sodium chloride. Participants report the saltiness sensation in the various control composition samples.

Calibration step: This step is added to the tasting process as another form of testing the panel's sensory threshold for saltiness and ability to recognize delicate variations. Panel members are given control composition samples of 5, 4, and 2 mg solid sodium chloride marked “A”, “B”, and “C”.

Tasting process: Tasting stages, excluding calibration, are conducted in the form of tasting a control composition versus enhanced salt composition. Each participant is given a control composition sample and a sample of an enhanced salt composition. Control composition samples are labeled “Control”; enhanced salt composition samples are marked with random numbers. Participants are instructed to rank saltiness sensation in reference to the control composition. Participants are given additional control composition samples if needed.

Participants are given two sets of tests in each tasting. Both sets include a single control composition sample and a single enhanced salt composition sample. The rest of the tests are conducted similarly, and each sample is tested with a sodium chloride control composition as a reference in two sets of tests.

While preferred embodiments of the present disclosure have been shown and described herein, it will be obvious to those skilled in the art that such embodiments are provided by way of example only. Numerous variations, changes, and substitutions will now occur to those skilled in the art without departing from the present disclosure. It should be understood that various alternatives to the embodiments of the present disclosure described herein may be employed in practicing the present disclosure. It is intended that the following claims define the scope of the present disclosure and that methods and structures within the scope of these claims and their equivalents be covered thereby.

What is claimed is:

1. A method of producing an enhanced salt composition, comprising mixing a salt with an enhancer compound to produce an enhanced salt composition; wherein the enhanced salt composition has enhanced saltiness compared to a control composition; and wherein the control composition consists of the same contents by identity and quantity as the enhanced salt composition but without the enhancer compound.

2. The method of claim 1, further comprising dissolving the salt and the enhancer compound to produce an enhanced salt composition solution.

3. The method of claim 2, further comprising adjusting a pH level of the enhanced salt composition solution.

4. The method of any one of claims 1-3, further comprising drying the enhanced salt composition or passing the enhanced salt composition through a sieve.

5. The method of any one of claims 1-4, further comprising sonicating or homogenizing the enhanced salt composition.

6. The method of any one of claims 1-5, wherein the salt is sodium chloride.

7. The method of any one of claims 1-6, wherein the enhancer compound is selected from the group consisting of an amino acid, peptide, protein, metal oxide, chitosan, chitin, and any combination thereof.

8. The method of claim 7, wherein the amino acid is selected from the group consisting of alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, selenocysteine, pyrrolysine, and any combination thereof.

9. The method of claim 7, wherein the peptide is selected from the group consisting of a dipeptide, tripeptide, tetrapeptide, pentapeptide, and any combination thereof.

10. The method of any one of claims 1-9, wherein the enhanced salt composition comprises up to about 10% enhancer compound weight/weight relative to salt.

11. The method of any one of claims 1-10, wherein the saltiness is enhanced by at least 10, 20, 30, 40, or 50%.

12. An enhanced salt composition comprising a salt and an enhancer compound; wherein the enhanced salt composition has up to about 10% enhancer compound weight/weight relative to salt; wherein the enhanced salt composition has enhanced saltiness compared to a control composition; and wherein the control composition consists of the same contents by identity and quantity as the enhanced salt composition but without the enhancer compound.

13. The enhanced salt composition of claim 12, wherein the salt is sodium chloride.

14. The enhanced salt composition of any one of claims 12-13, wherein the enhancer compound is selected from the group consisting of an amino acid, peptide, protein, metal oxide, chitosan, chitin, and any combination thereof.

15. The enhanced salt composition of claim 14, wherein the amino acid is selected from the group consisting of alanine, arginine, asparagine, aspartic acid, cysteine, glutamic acid, glutamine, glycine, histidine, isoleucine, leucine, lysine, methionine, phenylalanine, proline, serine, threonine, tryptophan, tyrosine, valine, selenocysteine, pyrrolysine, and any combination thereof.

16. The enhanced salt composition of claim 14, wherein the peptide is selected from the group consisting of a dipeptide, tripeptide, tetrapeptide, pentapeptide, and any combination thereof.

17. The enhanced salt composition of any one of claims 12-16, wherein the saltiness is enhanced by at least 10, 20, 30, 40, or 50%.

18. A composition comprising a food or consumable product comprising the enhanced salt composition of any one of claims 12-17.

19. The composition of claim 18, wherein the food or consumable product is selected from the group consisting of baked goods, condiments, sauces, dressings, meats, processed meats, hamburger, egg, vegetables, cereal, pies, quiche, pasta, meat substitute, tofu, peanuts, nuts, seeds, snacks, cheese, spices, soup, dairy products, and any combination thereof.

20. A method to make a food or consumable product comprising substituting at least a portion of a salt ingredient with the enhanced salt composition of any one of claims 12-17.
